(19) United States
(12) Patent Application Publication
(10) Pub. No.: US 2024/0231877 A1
(43) Pub. Date: Jul. 11, 2024

(54) OBJECT INPUT/OUTPUT SAMPLING FOR PERFORMANCE DIAGNOSIS IN VIRTUALIZED COMPUTING ENVIRONMENT

(71) Applicant: VMware, Inc., Palo Alto, CA (US)

(72) Inventors: Yang YANG, Shanghai (CN); Yang YANG, Shanghai (CN); Jianqiao SUN, Shanghai (CN); Chengmao LU, Shanghai (CN); Jianan FENG, Shanghai (CN)

(73) Assignee: VMware, Inc., Palo Alto, CA (US)

(21) Appl. No.: 18/128,243

(22) Filed: Mar. 30, 2023

(30) Foreign Application Priority Data
Jan. 6, 2023 (WO) PCT/CN2023/070821

(51) Int. Cl. G06F 9/455

(52) U.S. Cl. CPC G06F 9/45558; G06F 2009/4557; G06F 2009/45579; G06F 2009/45583; G06F 2009/45591

(57) ABSTRACT

An example method for sampling an input/output (I/O) to an object owned by an object owner is disclosed. The method includes receiving an I/O and determining whether a predetermined time interval exceeds. In response that the predetermined time interval does not exceed, the example method includes calculating a first sample score associated with the object owner, obtaining a second sample score associated with a component owner of the object and calculating a weighted sample score based on the first sample score and the sample score. In response that the weighted sample score is not less than a predetermined sample score, the example method includes sampling the I/O.

### CROSS-REFERENCE TO RELATED APPLICATION

The present application claims the benefit of Patent Cooperation Treaty (PCT) Application No. PCT/CN2023/070821, filed Jan. 6, 2023, which is incorporated herein by reference.

### BACKGROUND

Unless otherwise indicated herein, the approaches described in this section are not admitted to be prior art by inclusion in this section.

A virtualization software suite (vSphere Suite) for implementing and managing virtual infrastructures in a virtualized computing environment may include a hypervisor (ESXi) that implements virtual machines (VMs) on one or more physical hosts (hosts), a virtual storage area network (vSAN) software that aggregates local storage to form a shared datastore for a cluster of physical hosts, and a server management software (vCenter) that centrally provisions and manages virtual datacenters, VMs, hosts, clusters, datastores, and virtual networks.

The vSAN software uses the concept of a disk group as a container for solid-state drives (SSDs) and non-SSDs, such as hard disk drives (HDDs). On each host (node) in a vSAN cluster, the local drives of the host are organized into one or more disk groups. Each disk group includes one SSD that serves as read cache and write buffer (e.g., a cache tier), and one or more SSDs or non-SSDs that serve as permanent storage (e.g., a capacity tier). The aggregate of the disk groups from all the nodes forms a vSAN datastore distributed and shared across the nodes of the vSAN cluster.

The vSAN software stores and manages data in the form of data containers called objects. An object is a logical volume that has its data and metadata distributed across a vSAN cluster. For example, every virtual machine disk (VMDK) is an object, as is every snapshot. A virtual machine (VM) is provisioned on a vSAN datastore as a VM home namespace object, which stores metadata files of the VM including descriptor files for the VM's VMDKs. A user may operate a VM to perform input/output (I/O) operations to VMDKs of the VM. When a performance issue (e.g., a latency of the I/O operations) occurs due to one or more outstanding inputs/outputs (I/Os), network hardware issues, network congestions, or disk slowness, the user may manually trigger a diagnostic operation to the VM. The diagnostic operation may collect trace data associated with I/Os generated by the VM at each layer of the vSAN cluster and break down latencies between layers of the vSAN cluster based on the collected trace data.

However, this approach is not adequate because the performance issue may be temporary and the trace data cannot represent the state when the performance issue occurred. Even assuming trace data is constantly collected for potential diagnostics in the future, the constant collection of the trace data and the persisting of these collected trace data will significantly impact the performances of the entire vSAN datastore.

### BRIEF DESCRIPTION OF DRAWINGS

FIG. 1 is a schematic diagram illustrating an example virtualized computing environment to perform object I/O samplings for performance diagnosis;

FIG. 2 is a flowchart of an example process of an object owner to sample an I/O to an object owned by the object owner;

FIG. 3 is a flowchart of an example process of a primary node to aggregate trace data associated with a sampled I/O; and

FIG. 4 is a flowchart of an example process of a primary node to select a host to persist aggregated trace data associated with one or more sampled I/Os in a distributed storage system, all arranged in accordance with some embodiments of the disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting.

Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein.

In the following detailed description, an “object” is composed of one or more components distributed in an object store, such as a vSAN object store. A “component” is an entity that holds data for the object. A “client” may refer to a host which sends one or more I/Os to an object. An “object owner” may refer to a host which coordinates the I/Os to the object in an object store so that the object owner owns the object. A “component owner” may refer to a host which owns a component. Generally, the data held by a component is persisted on one or more disks of the component owner. “Sampling an I/O” may refer to an object owner configured to tag an I/O to an object owned by the object owner, record timepoints at each layer of a data path of this I/O and collect the recorded timepoints data. “Sampling an I/O” may be interchangeably used with “I/O sampling,” “object I/O sampling,” “I/O(s) . . . is(are) sampled” in the description. “Trace data” may refer to data associated with timepoints of a tagged I/O to an object at each layer of a data path of the tagged I/O.

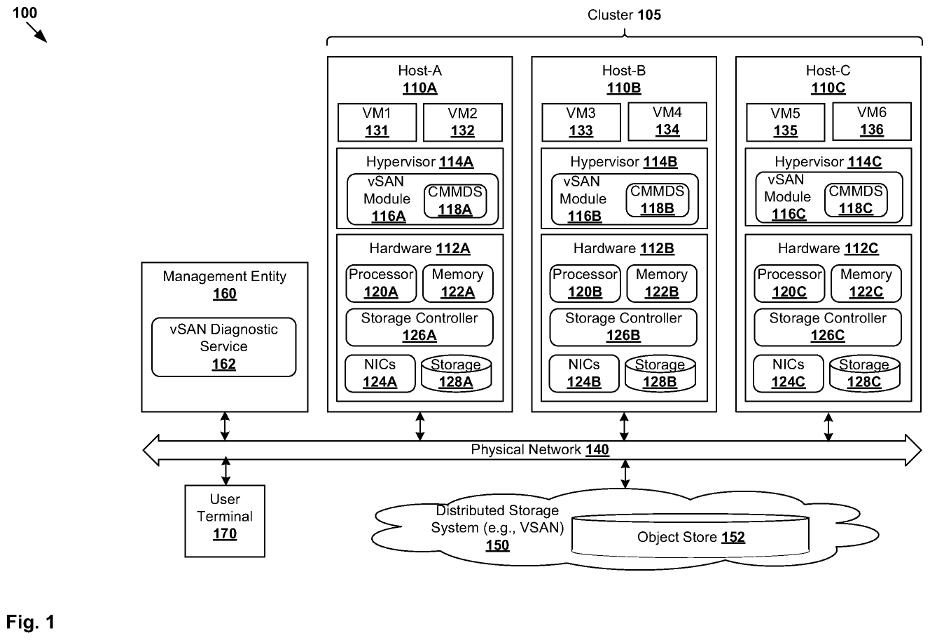

Challenges relating to performing object I/O samplings for performance diagnosis will now be explained in more detail using FIG. 1, which is a schematic diagram illustrating example virtualized computing environment 100. It should be understood that, depending on the desired implementation, virtualized computing environment 100 may include additional and/or alternative components than that shown in FIG. 1.

In the example in FIG. 1, virtualized computing environment 100 includes cluster 105 of multiple hosts, such as Host-A 110A, Host-B 1101B, and Host-C 110C. In the following, reference numerals with a suffix “A” relates to Host-A 110A, suffix “B” relates to Host-B 110B, and suffix “C” relates to Host-C 110C. Although three hosts (also known as “host computers”, “physical servers”, “server systems”, “host computing systems”, etc.) are shown for simplicity, cluster 105 may include any number of hosts. Although one cluster 105 is shown for simplicity, virtualized computing environment 100 may include any number of clusters.

Each host 110A/110B/110C in cluster 105 includes suitable hardware 112A/112B/112C and executes virtualization software such as hypervisor 114A/114B/114C to maintain a mapping between physical resources and virtual resources assigned to various virtual machines. For example, Host-A 110A supports VM1 131 and VM2 132; Host-B 110B supports VM3 133 and VM4 134; and Host-C 110C supports VM5 135 and VM6 136. In practice, each host 110A/110B/110C may support any number of virtual machines, with each virtual machine executing a guest operating system (OS) and applications. Hypervisor 114A/114B/114C may also be a “type 2” or hosted hypervisor that runs on top of a conventional operating system (not shown) on host 110A/1101B/110C.

Although examples of the present disclosure refer to “virtual machines,” it should be understood that a “virtual machine” running within a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances may include containers (e.g., running on top of a host operating system without the need for a hypervisor or separate operating system such as Docker, etc.; or implemented as an operating system level virtualization), virtual private servers, client computers, etc. The virtual machines may also be complete computation environments, containing virtual equivalents of the hardware and software components of a physical computing system.

Hardware 112A/112B/112C includes any suitable components, such as processor 120A/120B/120C (e.g., central processing unit (CPU)); memory 122A/122B/122C (e.g., random access memory); network interface controllers (NICs) 124A/124B/124C to provide network connection; storage controller 126A/126B/126C that provides access to storage resources 128A/128B/128C, etc. Corresponding to hardware 112A/112B/112C, virtual resources assigned to each virtual machine may include virtual CPU, virtual memory, virtual machine disk(s), virtual NIC(s), etc.

Storage controller 126A/126B/126C may be any suitable controller, such as a redundant array of independent disks (RAID) controller, etc. Storage resource 128A/128B/128C may represent one or more disk groups. In practice, each disk group represents a management construct that combines one or more physical disks, such as hard disk drive (HDD), solid-state drive (SSD), solid-state hybrid drive (SSHD), peripheral component interconnect (PCI) based flash storage, serial advanced technology attachment (SATA) storage, serial attached small computer system interface (SAS) storage, Integrated Drive Electronics (IDE) disks, Universal Serial Bus (USB) storage, etc.

Through storage virtualization, hosts 110A/110B/110C in cluster 105 aggregate their storage resources 128A/128B/128C to form distributed storage system 150, which represents a shared pool of storage resources. For example, in FIG. 1, Host-A 110A, Host-B 110B and Host-C 110C aggregate respective local physical storage resources 128A, 128B and 128C into object store 152 (also known as a datastore or a collection of datastores). In this case, data (e.g., virtual machine data) stored on object store 152 may be placed on, and accessed from, one or more of storage resources 128A/128B/128C. In practice, distributed storage system 150 may employ any suitable technology, such as Virtual Storage Area Network (vSAN) from VMware, Inc. Cluster 105 may be referred to as a vSAN cluster. In some embodiments, host-A 110 is a primary node of vSAN cluster 105 and other hosts (e.g., host-B 110B and host-C 110C) in vSAN cluster 105 are secondary nodes of vSAN cluster 105. The primary node is configured to monitor the state of the secondary nodes and detect issues within vSAN cluster 105.

In virtualized computing environment 100, management entity 160 provides management functionalities to various managed objects, such as cluster 105, hosts 110A/110B/110C, virtual machines 131, 132, 133, 134, 135 and 136, etc. Management entity 160 may include vSAN diagnostic service 162.

In some embodiments, a user operating on VM3 133 may determine that VM3 133 has performance issues (e.g., latencies) and the user may send a vSAN diagnostic service request for VM3 133 from user terminal 170 to vSAN diagnostic service 162. In response to receiving the vSAN diagnostic service request, vSAN diagnostic service 162 is configured to manage vSAN modules 116A, 116B and 116C to fulfill the vSAN diagnostic service request.

Conventionally, in response to receiving the vSAN diagnostic service request, management entity 160 is configured to query vSAN module 116A on primary node host-A 110A. vSAN module 116A is configured to coordinate vSAN modules 116B and 116C to start sampling one or more I/Os and collect trace data of the I/Os associated with VM3 133. In response to vSAN modules 116A/116B/116C collecting the trace data, vSAN module 116A may obtain the trace data from vSAN modules 116B/116C and aggregate and persist the trace data in object store 152. vSAN diagnostic service 162 is then configured to retrieve the persisted data from object store 152, perform performance and/or latency diagnostic based on the retrieved persisted data and transmit a diagnostic result to user terminal 170 for the user's review.

However, the conventional approach above has adoption issues. For example, the performance issues of VM3 133 may be temporary. Therefore, the trace data collected after the performance issues occurred cannot reflect the state of VM3 133 when the performance issues occurred. Accordingly, the diagnostic result based on the trace data generally leads to a diagnostic result which is not associated with the performance issues.

The adoption issues above may be overcome by constantly collecting trace data. Therefore, when the performance issues occur, vSAN diagnostic service 162 may be configured to perform performance and/or latency diagnostic based on the previously collected trace data. However, this approach also has problems. For example, constantly collecting trace data and persisting the collected trace data in object store 152 may impact overall performances of distributed storage system 150, such as shortage of storage spaces or latencies due to persisting significant amounts of collected trace data while distributed storage system 150 still needs to support other normal I/O operations in virtualized computing environment 100.

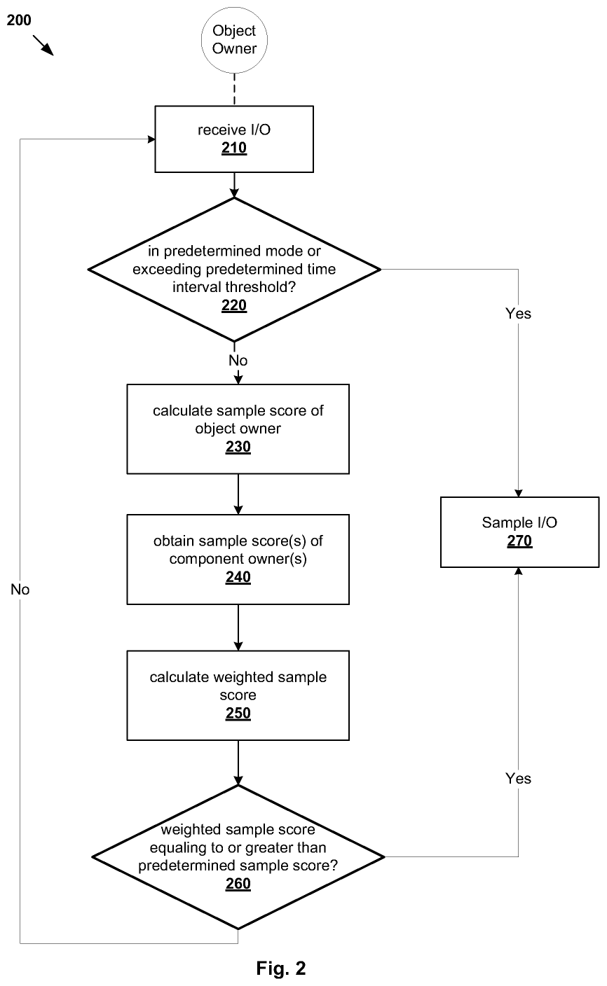

FIG. 2 is a flowchart of example process 200 of an object owner to sample an I/O to an object owned by the object owner, according to some embodiments of the disclosure. In some embodiments, in conjunction with FIG. 1, the object owner may be host-B 110B, host-C 110C or any other hosts in cluster 105. Example process 200 may include one or more operations, functions, or actions illustrated by one or more blocks, such as 210 to 270. The various blocks may be combined into fewer blocks, divided into additional blocks, and/or eliminated depending on the desired implementation.

In some embodiments, in conjunction with FIG. 1, primary node host-A 110A is configured to publish a resource-aware I/O sampling configuration in its cluster monitoring membership and directory service (i.e., CMMDS 118A) which can distribute the configuration to other CMMDS (e.g., CMMDS 118B and CMMDS 118C) in cluster 105. In some embodiments, in response to receiving the configuration from CMMDS, any of secondary nodes host-B 110B, host-C 110C and other hosts in cluster 105 is configured to sample an I/O to an object and collect trace data associated with the I/O.

In some embodiments, primary node host-A 110A is configured to periodically call an application program interface (API) of any secondary nodes to fetch the trace data collected by host-B 110B, host-C 110C and other hosts in cluster 105. Primary node host-A 110A is also configured to create an object on primary node host-A 110A to hold raw I/O trace data and/or aggregated I/O trace data.

In some embodiments, for illustration only, the trace data may include, but not limited to, a first timestamp of receiving a tagged I/O at the object owner, a second timestamp of completing the tagged I/O at the object owner, a third timestamp of receiving the tagged I/O at a first component owner, a fourth timestamp of completing the tagged I/O at the first component owner, a fifth timestamp of receiving the tagged I/O at a second component owner and a sixth timestamp of completing the tagged I/O at the second component owner.

More specifically, in some embodiments, for illustration only, the trace data may further include, but not limited to, a seventh timestamp of receiving the tagged I/O at a first disk of the first component owner, an eighth timestamp of completing the tagged I/O at the first disk of the first component owner, a ninth timestamp of receiving the tagged I/O at a second disk of the second component owner and a tenth timestamp of completing the tagged I/O at the second disk of the second component owner.

At block 210 in FIG. 2, in some embodiments and in conjunction with FIG. 1, assuming the host-B 110B is the object owner owns an object and host-C 110C is the component owner of the object, host-B 110B is configured to receive an I/O to the object. Block 210 may be followed by block 220.

At block 220 in FIG. 2, in some embodiments, host-B 110B is configured to determine whether the resource-aware I/O sampling configuration specifies an aggressive sampling mode or a resource-aware sampling mode. In response to determining that the configuration specifies the aggressive sampling mode, block 220 is followed by block 270 where host-B 110B is configured to sample the I/O in any event.

At block 220 in FIG. 2, in some embodiments, in response to determining that the configuration specifies the resource-aware mode, host-B 110B is configured to determine whether a predetermined time interval threshold exceeds. More specifically, the resource-aware I/O sampling configuration includes a maximum sampling time interval. The predetermined time interval corresponds to a time difference between the present time point at host-B 110B and the time point that host-B 110B performed the latest I/O sampling. In response to the time difference exceeding the maximum sampling time interval, host-B 110B determines that the predetermined time interval threshold exceeds and block 220 is followed by block 270 where host-B 110B is configured to sample the I/O. In response to the time difference does not exceed the maximum sampling time interval, host-B 110B determined that the determined time interval threshold does not exceed and block 220 is followed by block 230.

At block 230 in FIG. 2, in some embodiments, host-B 110B is configured to calculate a sample score of the object owner (i.e., host-B 110B). In some embodiments, the sample score may be calculated based on the following:

$$samplescoreCPU = ( hCPU [ now - 2 min ] - hCPU [ now - 1 min ] ) * {( hCPU [ now - 1 min ] - hCPU [ now ] )}^{2} * ( max CPU - hCPU [ now ] ) / maxCPU$$

$$samplescoreMEM = ( hMEM [ now - 2 min ] - hMEM [ now - 1 min ] ) * {( hMEM [ now - 1 min ] - hMEM [ now ] )}^{2} * ( maMEM - hMEM [ now ] ) / max MEM$$

$$samplescore = Max ( samplescoreCPU , samplescoreMEM , 0 )$$

hCPU[now-2 min] refers to the CPU usage of host-B 110B two minutes prior to the present time point, hCPU[now-1 min] refers to the CPU usages of host-B 110B one minute prior to the present time point, hCPU[now] refers to the CPU usage of host-B 110B at present time point, maxCPU refers to a total capacity of CPU of host-B 110B.

Similarly, hMEM[now-2 min] refers to the memory usage of host-B 110B two minutes prior to the present time point, hMEM[now-1 min] refers to the memory usage of host-B 110B one minute prior to the present time point, hMEM[now] refers to the memory usage of host-B 110B at present time point, maxMEM refers to a total capacity of memory of host-B 110B.

The sample score of the object owner is the maximum of (samplescoreCPU+samplescoreMEM) and 0.

In some embodiments, block 230 is followed by block 240. At block 240 in FIG. 2, in some embodiments, host-B 110B is configured to obtain a sample score of a component owner (e.g., host-C 110C). One component owner is described here for illustration only. The number of component owner may be plural, depending on distribution levels of components of the object in the distributed storage system.

In some embodiments, host-B 110B is configured to ask a component owner (e.g., host-C 110C) to calculate a sample score of the component owner. In some embodiments, the sample score of the component owner may be calculated based on the following. Similarly, assuming there are multiple component owners, corresponding sample score for each component owner may also be calculated based on the following:

$$samplescoreCPU = ( hCPU [ now - 2 min ] - hCPU [ now - 1 min ] ) * {( hCPU [ now - 1 min ] - hCPU [ now ] )}^{2} * ( max CPU - hCPU [ now ] ) / max CPU$$

$$samplescoreMEM = ( hMEM [ now - 2 min ] - hMEM [ now - 1 min ] ) * {( hMEM [ now - 1 min ] - hMEM [ now ] )}^{2} * ( maMEM - hMEM [ now ] ) / max MEM$$

$$samplescore = Max ( samplescoreCPU , samplescoreMEM , 0 )$$

hCPU[now-2 min] refers to a difference between the CPU usage of host-C 110C two minutes prior to the present time point, hCPU[now-1 min] refers to the CPU usage of host-C 110C one minute prior to the present time point, hCPU[now] refers to the CPU usage of host-C 110C at present time point, maxCPU refers to a total capacity of CPU of host-C 110C.

Similarly, hMEM[now-2 min] refers to the memory usage of host-C 110C two minutes prior to the present time point, hMEM[now-1 min] refers to the memory usage of host-C one minute prior to the present time point, hMEM[now] refers to the memory usage of host-C 110C at present time point, maxMEM refers to a total capacity of memory of host-C 110C.

The sample score of the component owner is the maximum of (samplescoreCPU+samplescoreMEM) and 0. In some embodiments, object owner host-B 110B is configured to obtain the sample score of the component owner host-C 110C after host-C 110C calculates its own sample score.

In some embodiments, block 240 is followed by block 250. At block 250 in FIG. 2, in some embodiments, host-B 110B is configured to calculate a weighted sample score for the I/O received at block 210 based on the sample score of the object owner calculated at block 230 and the sample score of the component owner obtained at block 240. In some embodiments, the weighted sample score may be calculated based on the following:

$$weightedsamplescore = Min [ α * ( object owner sample score ) , β * ( component owner sample score ) ] + γ / ( 1 + {e}^{( - \frac{1}{curTime - 1 stTime - maximum sampling time interval} )} )$$

“object owner sample score” is the sample score calculated at block 230, “component owner sample score” is the sample score obtained at block 240, “curtime” refers to the present time point, “1 stTime” refers to the time point that host-B 110B performs the latest I/O sampling, “maximum sampling time interval” refers to the maximum sampling time interval included in the resource-aware I/O sampling configuration, a, 8 and 7 are weight parameters which can be adjustable by an administrator. Block 250 may be followed by block 260.

In some embodiments, host-B 110B is configured to determine whether the weighted sample score calculated at block 250 equals to or is greater than a predetermined sample score. The predetermined sample score may be 7. In response to determining that the weighted sample score calculated at block 250 equals to or is greater than a predetermined sample score, block 260 is followed by block 270 and host-B 110B is configured to sample the I/O.

In some embodiments, in response to determining that the weighted sample score calculated at block 250 is less than a predetermined sample score, block 260 is followed by block 210. Accordingly, host-B 110B is configured not to sample the I/O. In addition, when the next I/O is received by host-B 110B at block 210, process 200 will repeat to determine whether to sample this next I/O.

Based on the above approaches, not every I/O is sampled. Therefore, the trace data associated with the I/O may be selectively collected for diagnosis for a future performance issue. Compared to the conventional approach that the trace data being collected after the performance issue, the above approaches may be more likely to reflect the state when the performance issue occurs and a more accurate diagnostic result may be obtained.

In addition, based on the above approaches, the sample score of the object owner at block 230 will be higher when an object owner has more CPU or memory resources being freed up shortly. Similarly, the sample score of a component owner at block 240 will also be higher when the component owner has more CPU or memory resources being freed up shortly. Therefore, in conjunction with FIG. 1, an I/O may be sampled when the object owner and the component owner potentially have more resources, which may reduce impacts to the overall performances of distributed storage system 150.

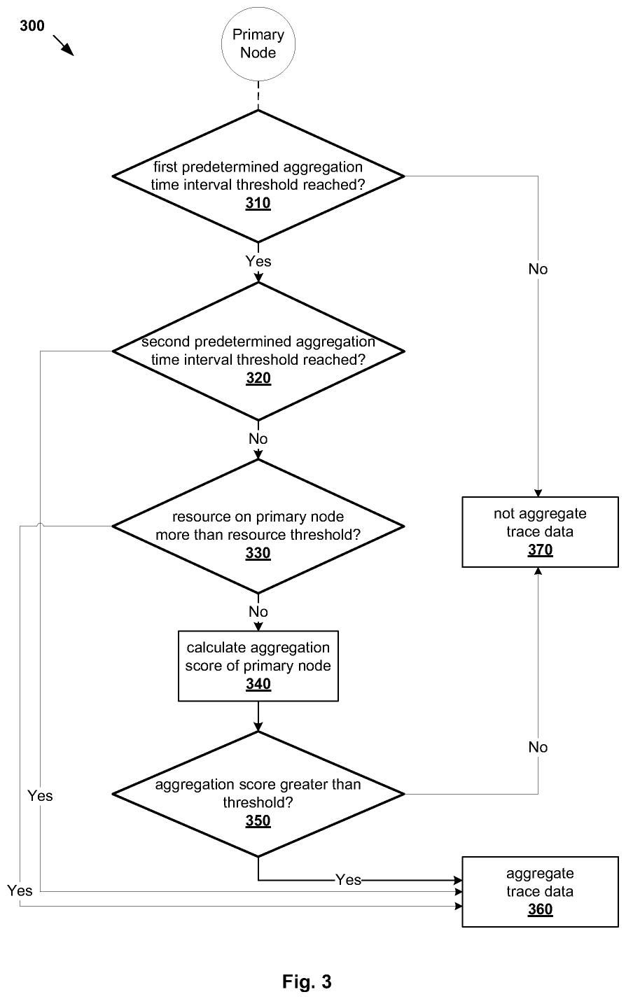

FIG. 3 is a flowchart of example process 300 of a primary node to aggregate trace data associated with a sampled I/O, according to some embodiments of the disclosure. In some embodiments, in conjunction with FIG. 1, the primary node may be host-A 110A. Example process 300 may include one or more operations, functions, or actions illustrated by one or more blocks, such as 310 to 370. The various blocks may be combined into fewer blocks, divided into additional blocks, and/or eliminated depending on the desired implementation.

In some embodiments, the aggregation of trace data may include, but not limited to, calculate a latency between any of two timestamps (i.e., first timestamp, second timestamp, third timestamp, fourth timestamp, fifth timestamp, sixth timestamp, seventh timestamp, eighth timestamp, ninth timestamp and tenth timestamp) described above. Moreover, assuming there are multiple latencies obtained, the aggregation may also include, but not limited to, performing average and standard deviation operations on these latencies. In addition, the aggregation may also include, but not limited to, identifying the maximum latency or the minimum latency among the multiple latencies.

At block 310, in some embodiments and in conjunction with FIG. 1, host-A 110A is configured to calculate a time difference between the present time point at host-A 110A and the time point that the host-A 110A performed the latest aggregations of sampled I/Os. Host-A 110A is further configured to determine whether the time difference reaches a first predetermined aggregation time interval threshold. The first predetermined aggregation time interval can be adjustable by an administrator. For example, the first predetermined aggregation time interval may be one hour. In response to that the time difference does not reach the first predetermined aggregation time interval threshold, block 310 may be followed by block 370 and host-A 110A is configured not to aggregate trace data associated with one or more sampled I/Os. In contrary, in response to that the time difference reaches the first predetermined aggregation time interval threshold, block 310 may be followed by block 320.

At block 320, in some embodiments and in conjunction with FIG. 1, host-A 110A is configured to determine whether the time difference calculated at block 310 reaches a second predetermined aggregation time interval threshold. The second predetermined aggregation time interval threshold is greater than the first predetermined aggregation time interval threshold. In some embodiments, the second predetermined aggregation time interval threshold may be a multiple of the first predetermined aggregation time interval threshold. For example, the second predetermined aggregation time interval threshold may be 1.1 hours. In response to that the time difference reaches the second predetermined aggregation time interval threshold, block 320 may be followed by block 360 and host-A 110A is configured to aggregate trace data associated with one or more sampled I/Os. In contrary, in response to that the time difference does not reach the second predetermined aggregation time interval threshold, block 320 may be followed by block 330.

At block 330, in some embodiments and in conjunction with FIG. 1, host-A 110A is configured to determine whether available resources (e.g., available CPU capability and available memory capability) on host-A 110A are more than a resource threshold. The resource threshold may be adjustable by an administrator. In response to a determination that available resources on host-A 110A are more than the resource threshold, which means that host-A 110A has feasible resources to aggregate trace data associated with one or more sampled I/Os and the aggregation may only bring limited impacts to performances of distributed storage system 150, block 330 is followed by block 360 and host-A 110A is configured to aggregate trace data associated with one or more sampled I/Os. In response to a determination of available resources on host-A 110A are not more than the resource threshold, block 330 is followed by block 340.

At block 340, in some embodiments and in conjunction with FIG. 1, host-A 110A is configured to calculate an aggregation score of host-A 110A. In some embodiments, the aggregation score of host-A 110A may be calculated based on the following:

$$aggregationscoreCPU = ( hCPU [ now - 2 min ] - h CPU [ now - 1 min ] ) * {( hCPU [ now - 1 min ] - hCPU [ now ] )}^{2} * ( max CPU - hCPU [ now ] ) / max CPU$$

$$aggregationscoreMEM = ( hMEM [ now - 2 min ] - hMEM [ now - 1 min ] ) * {( hMEM [ now - 1 min ] - hMEM [ now ] )}^{2} * ( maMEM - hMEM [ now ] ) / max MEM$$

$$aggregationscore = Max ( aggregationscoreCPU , aggregationscoreMEM , 0 )$$

hCPU[now-2 min] refers to the CPU usage of host-A 110A two minutes prior to the present time point, hCPU[now-1 min] refers to the CPU usage of host-A 110A one minute prior to the present time point, hCPU[now] refers to the CPU usage of host-A 110A at present time point, maxCPU refers to a total capacity of CPU of host-A 110A. Similarly, hMEM[now-2 min] refers to the memory usage of host-A 110A two minutes prior to the present time point, hMEM[now-1 min] refers to the memory usage of host-A 110A one minute prior to the present time point, hMEM[now] refers to the memory usage of host-A 110A at present time point, maxMEM refers to a total capacity of memory of host-A 110A.

$$The aggregation score of host ‐ A 110 A is the maximum of ( aggregationscoreCPU + aggregationscoreMEM ) and 0.$$

In some embodiments, block 340 is followed by block 350. At block 350, in some embodiments and in conjunction with FIG. 1, host-A 110A is configured to determine whether the aggregation score calculated at block 340 higher than a threshold. The threshold may be adjustable by an administrator. In response to a determination that the aggregation score is higher than the threshold, block 350 is followed by block 360 and host-A 110A is configured to aggregate trace data associated with one or more sampled I/Os. In response to a determination that the aggregation score is not higher than the threshold, block 350 is followed by block 370 and host-A 110A is configured not to aggregate trace data associated with one or more sampled I/Os. Therefore, based on example process 300, host-A 110A may be configured to aggregate trace data when host-A 110A has feasible resources (i.e., YES at block 330) or host-A 110A has more CPU or memory resources being freed up shortly (i.e., YES at block 350), which will reduce performance impacts to distributed storage system 150.

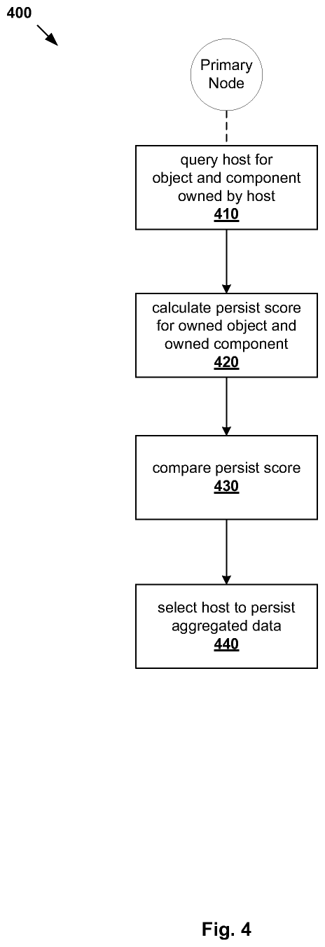

FIG. 4 is a flowchart of example process 400 of a primary node to select a host to persist aggregated trace data associated with one or more sampled I/Os in a distributed storage system, according to some embodiments of the disclosure. In some embodiments, in conjunction with FIG. 1, the primary node may be host-A 110A. Example process 400 may include one or more operations, functions, or actions illustrated by one or more blocks, such as 410 to 440. The various blocks may be combined into fewer blocks, divided into additional blocks, and/or eliminated depending on the desired implementation.

As described above, in conjunction with FIG. 1, primary node host-A 110A is configured to create an object on primary node host-A 110A to hold raw I/O trace data and/or aggregated I/O trace data. Typically, the object is locally stored on host-A 110A. Host-A 110A is configured to select a host in cluster 105 other than itself to persist the aggregated I/O trace data and/or some of the raw I/O trace data in distributed storage system 150.

At block 410, in some embodiments and in conjunction with FIG. 1, host-A 110A is configured to query all other hosts in cluster 105 in sequence, for illustration only, host-A 110A is configured to query host-B 110B and then host-C 110C. In some embodiments, host-A 110A is configured to obtain which objects are owned by host-B 110B and which components are owned by host-B 110B based on the query from host-A 110A to host-B 110B. Assuming host-B 110B owns a first object and a first component, host-A 110A is also configured to obtain a first time point that host-B 110B sampled the latest I/O to the first object and a second time point that host-B 110B sampled the latest I/O to the first component based on the query.

Similarly, in some embodiments, host-A 110A is configured to obtain which objects are owned by host-C 110C and which components are owned by host-C 110C based on the query from host-A 110A to host-C 110C. Assuming host-C 110C does not own any object but owns a second component, host-A 110A is also configured to obtain a third time point that host-C 110C sampled the latest I/O to the second component based on the query. Block 410 may be followed by block 420.

At block 420, in some embodiments and in conjunction with FIG. 1, host-A 110A is configured to calculate first, second and third persist scores based on the first time point, the second time point and the third time point, respectively. For illustration only, host-A 110A is configured to calculate a first persist score for the first object owned by host-B 110B. The first persist score is calculated based on:

$$\frac{α}{( now - 1 s t T i m e ( 1 st object ) + 1 )}$$

“now” refers to the present time point on host-B 110B, “1stTime(1stobject)” refers to the time point that host-B 110B sampled the latest I/O to the first object owned by host-B 110B and a is a weighting parameter. In some embodiments, the first persist score is inversely proportional to a first time difference between the present time point on host-B 110B and the first time point.

Similarly, in some embodiments, host-A 110A is also configured to calculate a second persist score for the first component owned by host-B 110B. The second persist score is calculated based on:

$$\frac{β}{( now - 1 st Time ( 1 st component ) + 1 )}$$

“now” refers to the present time point on host-B 110B, “1stTime(1stcomponent)” refers to the time point that host-B 110B sampled the latest I/O to the first component owned by host-B 110B and 3 is a weighting parameter.

In addition, in some embodiments, host-A 110A is also configured to calculate a third persist score for the second component owned by host-C 110C. The third persist score is calculated based on:

$$\frac{β}{( now - 1 st Time ( 2 nd component ) + 1 )}$$

“now” refers to the present time point on host-C 110C, “1stTime(2ndcomponent)” refers to the time point that host-C 110C sampled the latest I/O to the second component owned by host-C 110C and 3 is a weighting parameter. In some embodiments, the second persist score is inversely proportional to a second time difference between the present time point on host-B 110B and the second time point and the third persist score is inversely proportional to a third time difference between the present time point on host-C 110C and the third time point. Block 420 may be followed by block 430.

At block 430, in some embodiments and in conjunction with FIG. 1, host-A 110A is configured to compare persist scores calculated at block 420 and determine the maximum of the persist scores. Block 430 may be followed by block 440.

At block 440, in some embodiments and in conjunction with FIG. 1 and FIG. 3, host-A 110A is configured to determine a host associated with the maximum persist score to be the host to persist aggregated tracing data at block 360 in distributed storage system 150. Based on the above, for illustration only, assuming the third persist score is the maximum among the first, second and third persist scores, the maximum persist score indicates that host-C 110C is the host which samples an I/O most recently in cluster 105. This makes host-C 110C more likely to have more time before host-C 110C performs the next I/O sampling. Therefore, host-C 110C may have more resources to persist aggregated tracing data at block 360 than any other hosts in cluster 105. Accordingly, host-A 110A is configured to transmit aggregated tracing data at block 360 to host-C 110C and instruct host-C 110C to persist the aggregated tracing data to distributed storage system 150.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

It will be understood that although the terms “first,” “second,” third” and so forth are used herein to describe various elements, these elements should not be limited by these terms. These terms are only used to distinguish one element from another. For example, within the scope of the present disclosure, a first element may be referred to as a second element, and similarly a second element may be referred to as a first element. As used herein, the term “and/or” includes any and all combinations of one or more of the associated listed items.

The drawings are only illustrations of an example, wherein the units or procedure shown in the drawings are not necessarily essential for implementing the present disclosure. Those skilled in the art will understand that the units in the device in the examples can be arranged in the device in the examples as described, or can be alternatively located in one or more devices different from that in the examples. The units in the examples described can be combined into one module or further divided into a plurality of sub-units.

1. A method for an object owner to sample an input/output (I/O) to an object owned by the object owner, wherein the method comprises:
receiving, by the object owner, an I/O;
determining, by the object owner, whether a predetermined time interval threshold exceeds, wherein the predetermined time interval is specified in a resource-aware I/O sampling configuration distributed by a primary node of a virtual storage area network (vSAN) cluster through a cluster monitoring membership and directory service of the vSAN cluster;
in response to determining that the predetermined time interval threshold does not exceed,
calculating, by the object owner, a first sample score associated with the object owner;
obtaining, by the object owner, a second sample score associated with a component owner of the object;
calculating, by the object owner, a weighted sample score based on the first sample score and the sample score; and
in response to the weighted sample score not less than a predetermined sample score, sampling, by the object owner, the I/O.

2. The method of claim 1, further comprising, in response to determining that the predetermined time interval threshold exceeds or receiving a predetermined sampling mode specified in the resource-aware I/O sampling configuration, sampling, by the object owner, the I/O.

3. The method of claim 1, further comprising, in response to the weighted sample score equaling to or greater than the predetermined sample score, determining, by the object owner, not to sample the I/O.

4. The method of claim 1, wherein the first sample score corresponds to a first likelihood that a first resource of the object owner being freed up and the second sample score corresponds to a likelihood that a second resource of the object component being freed up.

5. A method for a primary node of a virtual storage area network (vSAN) cluster to aggregate trace data associated with a sampled I/O, wherein the trace data is fetched from secondary nodes of the vSAN cluster and the method comprises:
determining, by the primary node, whether a first predetermined aggregation time interval threshold reaches;
in response to determining the first predetermined aggregation time interval threshold being reached, determining, by the primary node, whether a second predetermined aggregation time interval threshold reaches;
in response to determining the second predetermined aggregation time interval threshold not being reached, determining, by the primary node, whether resources on the primary node are more than a resource threshold;
in response to determining that resources on the primary node are not more than the resource threshold, calculating, by the primary node, an aggregation score of the primary node; and
in response to the aggregation score greater than an aggregation score threshold, aggregating, by the primary node, the trace data.

6. The method of claim 5, further comprising, in response to determining the second predetermined aggregation time interval threshold have been reached, aggregating, by the primary node, the trace data.

7. The method of claim 5, further comprising, in response to determining that resources on the primary node are more than the resource threshold, aggregating, by the primary node, the trace data.

8. The method of claim 5, wherein the aggregating the trace data includes creating, by the primary node, an object to hold the trace data on the primary node.

9. The method of claim 5, wherein the aggregating the trace data includes calculating latencies between timestamps in the trace data, performing average and standard deviation operations on the latencies and identifying the maximum or the minimum among the latencies.

10. The method of claim 5, further comprising:
querying, by the primary node, a first host and a second host in the vSAN cluster to obtain a first time point that the first host performs the latest sampling to a first I/O to a first object or a first component owned by the first host and a second time point that the second host performs the latest sampling to a second I/O to a second object or a second component owned by the second host;
calculating, by the primary node, a first time difference between a present time point and the first time point and a second time difference between the present time point and the second time point;
comparing, by the primary node, the first time difference and the second time difference to determine whether the first time difference is greater than the second time difference; and
in response to determining the first time difference greater than the second time difference, selecting, by the primary node, the second host to persist the aggregated trace data in the vSAN cluster.

11. The method of claim 10, wherein the selecting the second host to persist the trace data in the vSAN cluster further includes transmitting, by the primary node, the aggregated trace data to the second host.

12. A first host to sample an input/output (I/O) to an object owned by the object owner, wherein the first host includes a processor; and
a non-transitory computer-readable medium having stored thereon instructions that, in response to execution by the processor, cause the processor to:
receive an I/O;
determine whether a predetermined time interval threshold exceeds, wherein the predetermined time interval is specified in a resource-aware I/O sampling configuration distributed by a primary node of a virtual storage area network (vSAN) cluster through a cluster monitoring membership and directory service of the vSAN cluster;
in response to determining that the predetermined time interval threshold does not exceed,
calculate a first sample score associated with the object owner;
obtain a second sample score associated with a component owner of the object;
calculate a weighted sample score based on the first sample score and the sample score; and
in response to the weighted sample score not less than a predetermined sample score, sample the I/O.

13. The first host of claim 12, wherein the non-transitory computer-readable medium having stored thereon additional instructions that, in response to execution by the processor, cause the processor to, in response to determining that the predetermined time interval threshold exceeds or receiving a predetermined sampling mode specified in the resource-aware I/O sampling configuration, sample the I/O.

14. The first host of claim 12, wherein the non-transitory computer-readable medium having stored thereon additional instructions that, in response to execution by the processor, cause the processor to, in response to the weighted sample score equaling to or greater than the predetermined sample score, determine not to sample the I/O.

15. The first host of claim 12, wherein the first sample score corresponds to a first likelihood that a first resource of the object owner being freed up and the second sample score corresponds to a likelihood that a second resource of the object component being freed up.

16. A second host to aggregate trace data associated with a sampled I/O, wherein the trace data is fetched from secondary nodes of a virtual storage area network (vSAN) cluster and the second host includes a processor; and
a non-transitory computer-readable medium having stored thereon instructions that, in response to execution by the processor, cause the processor to:
determine whether a first predetermined aggregation time interval threshold reaches;
in response to determining the first predetermined aggregation time interval threshold being reached, determine whether a second predetermined aggregation time interval threshold reaches;
in response to determining the second predetermined aggregation time interval threshold not being reached, determine whether resources on the second host are more than a resource threshold;
in response to determining that resources on the second host are not more than the resource threshold, calculate an aggregation score of the second host; and
in response to the aggregation score greater than an aggregation score threshold, aggregate the trace data.

17. The second host of claim 16, wherein the non-transitory computer-readable medium having stored thereon additional instructions that, in response to execution by the processor, cause the processor to, in response to determining the second predetermined aggregation time interval threshold have been reached, aggregate the trace data.

18. The second host of claim 16, wherein the non-transitory computer-readable medium having stored thereon additional instructions that, in response to execution by the processor, cause the processor to, in response to determining that resources on the primary node are more than the resource threshold, aggregate the trace data.

19. The second host of claim 16, wherein the non-transitory computer-readable medium having stored thereon additional instructions that, in response to execution by the processor, cause the processor to create an object to hold the trace data on the second host.

20. The second host of claim 16, wherein the non-transitory computer-readable medium having stored thereon additional instructions that, in response to execution by the processor, cause the processor to calculate latencies between timestamps in the trace data, perform average and standard deviation operations on the latencies and identify the maximum or the minimum among the latencies.

21. The second host of claim 16, wherein the non-transitory computer-readable medium having stored thereon additional instructions that, in response to execution by the processor, cause the processor to:
query a first host and a second host in the vSAN cluster to obtain a first time point that the first host performs the latest sampling to a first I/O to a first object or a first component owned by the first host and a second time point that the second host performs the latest sampling to a second I/O to a second object or a second component owned by the second host;
calculate a first time difference between a present time point and the first time point and a second time difference between the present time point and the second time point;
compare the first time difference and the second time difference to determine whether the first time difference is greater than the second time difference; and
in response to determining the first time difference greater than the second time difference, select the second host to persist the aggregated trace data in the vSAN cluster.

22. The second host of claim 16, wherein the non-transitory computer-readable medium having stored thereon additional instructions that, in response to execution by the processor, cause the processor to transmit the aggregated trace data to the second host.
